(19) United States
(12) Patent Application Publication
(10) Pub. No.: US 2017/0109615 A1
(43) Pub. Date: Apr. 20, 2017

(54) Systems and Methods for Automatically Classifying Businesses from Images

(71) Applicant: Google Inc., Mountain View, CA (US)

(72) Inventors: Liron Yatziv, Sunnyvale, CA (US); Yair Movshovitz-Attias, Pittsburgh, PA (US); Qian Yu, Santa Clara, CA (US); Martin Christian Stumpe, Sunnyvale, CA (US); Vinay Damodar Shet, Millbrae, CA (US); Sacha Christophe Arnoud, San Francisco, CA (US)

(21) Appl. No.: 14/885,452

(22) Filed: Oct. 16, 2015

(51) Int. Cl. G06K 9/66; G06F 17/30; G06K 9/62

(52) U.S. Cl. CPC G06K 9/66; G06K 9/6267; G06K 9/6256; G06F 17/30247; G06F 17/30268

(57) ABSTRACT

Computer-implemented methods and systems for automatically classifying businesses from imagery can include providing one or more images of a location entity as input to a statistical model that can be applied to each image. A plurality of classification labels for the location entity in the one or more images can be generated and provided as an output of the statistical model. The plurality of classification labels can be generated by selecting from an ontology that identifies predetermined relationships between location entities and categories associated with corresponding classification labels at multiple levels of granularity. Confidence scores for the plurality of classification labels can be generated to indicate a likelihood level that each generated classification label is accurate for its corresponding location entity. Associations based on the classification labels generated for each image can be stored in a database and used to help retrieve relevant business information requested by a user.

### FIELD

The present disclosure relates generally to image classification, and more particularly to automated features for providing classification labels for businesses or other location entities based on images.

### BACKGROUND

Computer-implemented search engines are used generally to implement a variety of services for a user. Search engines can help a user to identify information based on identified search terms, but also to locate businesses or other location entities of interest to a user. Often times, search queries are performed that are locality-aware, e.g., by taking into account the current location of a user or a desired location for which a user is searching for location-based entity information. Examples of such queries can be initiated by entering a location term (e.g., street address, latitude/longitude position, “near me” or other current location indicator) and other search terms (e.g., pizza, furniture, pharmacy). Having a comprehensive database of entity information that includes accurate business listing information can be useful to respond to these types of search queries. Existing databases of business listings can include pieces of information including business names, locations, hours of operation, and even street level images of such businesses, offered within services such as Google Maps as “Street View” images. Including additional database information that accurately identifies categories associated with each business or location entity can also be helpful to accurately respond to location-based search queries from a user.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of providing classification labels for location entities from imagery. The method can include providing, using one or more computing devices, one or more images of a location entity as input to a statistical model. The method can also include applying, by the one or more computing devices, the statistical model to the one or more images. The method can also include generating, using the one or more computing devices, a plurality of classification labels for the location entity in the one or more images. The plurality of classification labels can be generated by selecting from an ontology that identifies predetermined relationships between location entities and categories associated with corresponding classification labels at multiple levels of granularity. The method can still further include providing, using the one or more computing devices, the plurality of classification labels as an output of the statistical model.

Another example aspect of the present disclosure is directed to a computer-implemented method of processing a business-related search query. The method can include receiving, using one or more computing devices, a request for listing information for a particular type of business. The method can also include accessing, using the one or more computing devices, a database of business listings that comprises businesses, images of the businesses, and associations between the businesses and multiple classification labels. The associations between the businesses and multiple classification labels can be identified by providing each image of a business as input to a statistical model, applying the statistical model to each image of the business, generating the multiple classification labels for the business, and providing the multiple classification labels for the business as output of the statistical model. The method can also include providing, using the one or more computing devices, listing information including one or more business listings identified from the database of business listings at least in part by consulting the associations between the businesses and multiple classification labels.

Other example aspects of the present disclosure are directed to systems, apparatus, tangible, non-transitory computer-readable media, user interfaces, memory devices, and electronic devices for estimating restaurant wait times and/or food serving times using mobile computing devices.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides an example overview of providing classification labels for a location entity according to example aspects of the present disclosure;

FIGS. 2A-2C display images depicting the multi label nature of business classifications according to example aspects of the present disclosure;

FIGS. 3A-3C display images depicting image differences without available text information as can be used to provide classification labels for a business according to example aspects of the present disclosure;

FIGS. 4A-4C display images depicting potential problems for relying solely on available text to provide classification labels;

FIG. 5 provides a portion of an example ontology describing relationships between geographical entities assigned classification labels at multiple granularities according to example aspects of the present disclosure;

FIG. 6 provides a flow chart of an example method of providing classification labels for a location entity according to example aspects of the present disclosure;

FIG. 7 depicts an example set of input images and output classification labels and corresponding confidence scores generated according to example aspects of the present disclosure;

FIG. 8 provides a flow chart of an example method of applying classification labels for a location entity according to example aspects of the present disclosure;

FIG. 9 provides a flow chart of an example method of processing a business-related search query according to example aspects of the present disclosure; and

FIG. 10 provides an example overview of system components for implementing a method of providing classification labels for a location entity according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In some embodiments, in order to obtain the benefits of the techniques described herein, the user may be required to allow the collection and analysis of image data, location data, and other relevant information collected for various location entities. For example, in some embodiments, users may be provided with an opportunity to control whether programs or features collect such data or information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable data or other information is removed.

Example aspects of the present disclosure are directed to systems and methods of providing classification labels for a location entity based on images. Following the popularity of smart mobile devices, search engine users today perform a variety of locality-aware queries, such as “Japanese restaurant near me,” “Food nearby open now,” or “Asian stores in San Diego.” With the help of local business listings, these queries can be answered in a way that can be tailored to the user's location.

Creating accurate listings of local businesses can be time consuming and expensive. It is not a trivial task for humans to categorize such business listings, since human categorization requires abilities to read the local language, be familiar with local chains and brands, and generally become experts in complex categorization. To be useful for a search engine, the listings need to be accurate, extensive, and importantly, contain a rich representation of the business category including more than one category. For example, recognizing that a “Japanese Restaurant” is a type of “Asian Store” that sells “Food” can be important in accurately answering a large variety of queries.

In addition to the complexities of creating accurate and comprehensive business listings, listing maintenance can be a never ending task as businesses often move or close down. It is estimated that about 10 percent of establishments go out of business every year. In some segments of the market, such as the restaurant industry, this rate can be as high as about 30 percent. The time, expense, and continuing maintenance of creating an accurate and comprehensive database of categorized business listings makes a compelling case for new technologies to automate the creation and maintenance of business listings.

The embodiments according to example aspects of the present disclosure can automatically create classification labels for location entities from images of the location entities. In general, this can be accomplished by providing location entity images as an input to a statistical model (e.g., a neural network or other model implemented through a machine learning process.) The statistical model then can be applied to the image, at which point a plurality of classification labels for the location entity in the image can be generated and provided as an output of the statistical model. In some examples, a confidence score also can be generated for each of the plurality of classification labels to indicate a likelihood level that each generated classification label is accurate for its corresponding location entity.

Types of images and image preparation can vary in different embodiments of the disclosed technology. In some examples, the images correspond to panoramic street-level images, such as those offered by Google Maps as “Street View” images. In some examples, a bounding box can be applied to the images to identify at least one portion of each image that contains business related information. This identified portion can then be applied as an input to the statistical model.

Types of classification labels also can vary in different embodiments of the disclosed technology. In some examples, the location entities correspond to businesses such that classification labels provide multi-label fine grained classification of business storefronts. In some examples, the plurality of classification labels for the location entity identified in the images includes at least one classification label from a first hierarchical level of categorization and at least one classification label from a second hierarchical level of categorization. In some examples, the plurality of classification labels are generated by selecting from an ontology that identifies different predetermined relationships between location entities and different categories associated with corresponding classification labels at multiple levels of granularity. In some examples, the plurality of classification labels for the location entity can include at least one classification label from a general level of categorization that includes such options as an entertainment and recreation label, a health and beauty label, a lodging label, a nightlife label, a professional services label, a food and drink label and a shopping label.

Training the neural network or other statistical model can include using a set of training images of different location entities and data identifying the geographic location of the location entities within the training images, such that the neural network outputs a plurality of classification labels for each training image. In some examples, the neural network can be a distributed and scalable neural network. In some examples, the neural network can be a deep neural network and/or a convolutional neural network. The neural network can be customized in a variety of manners, including providing a specific top layer such as but not limited to a logistics regression top layer.

The generated plurality of classification labels provided as output from the neural network or other statistical model can be utilized in variety of specific applications. In some examples, the images provided as input to the neural network are subsequently tagged with one or more of the plurality of classification labels generated as output. In some examples, an association between the location entity associated with each image and the plurality of generated classification labels can be stored in a database. In some examples, the location entities from the images correspond to businesses and the database of stored associations includes business information for the businesses as well as the associations between the business associated with each image and the plurality of generated classification labels. In some examples, images can be matched to an existing business in the database using the plurality of generated classification labels at least in part to perform the matching. In other examples, a request from a user for business information can be received. The requested business information then can be retrieved from the database that includes the stored associations between the business associated with an image and the plurality of generated classification labels.

According to an example embodiment, a search engine receives requests for various business-related, location-aware search queries, such as a request for listing information for a particular type of business. The request can optionally include additional time or location parameters. A database of business listings that comprises businesses, images of the businesses, and associations between the businesses and multiple classification labels can be accessed. In some examples, the associations between the businesses and multiple classification labels can be identified by providing each image of a business as input to a statistical model, applying the statistical model to each image of the business, generating the multiple classification labels for the business, and providing the multiple classification labels for the business as output of the statistical model. Listing information then can be provided as output, including one or more business listings identified from the database of business listings at least in part by consulting the associations between the businesses and multiple classification labels.

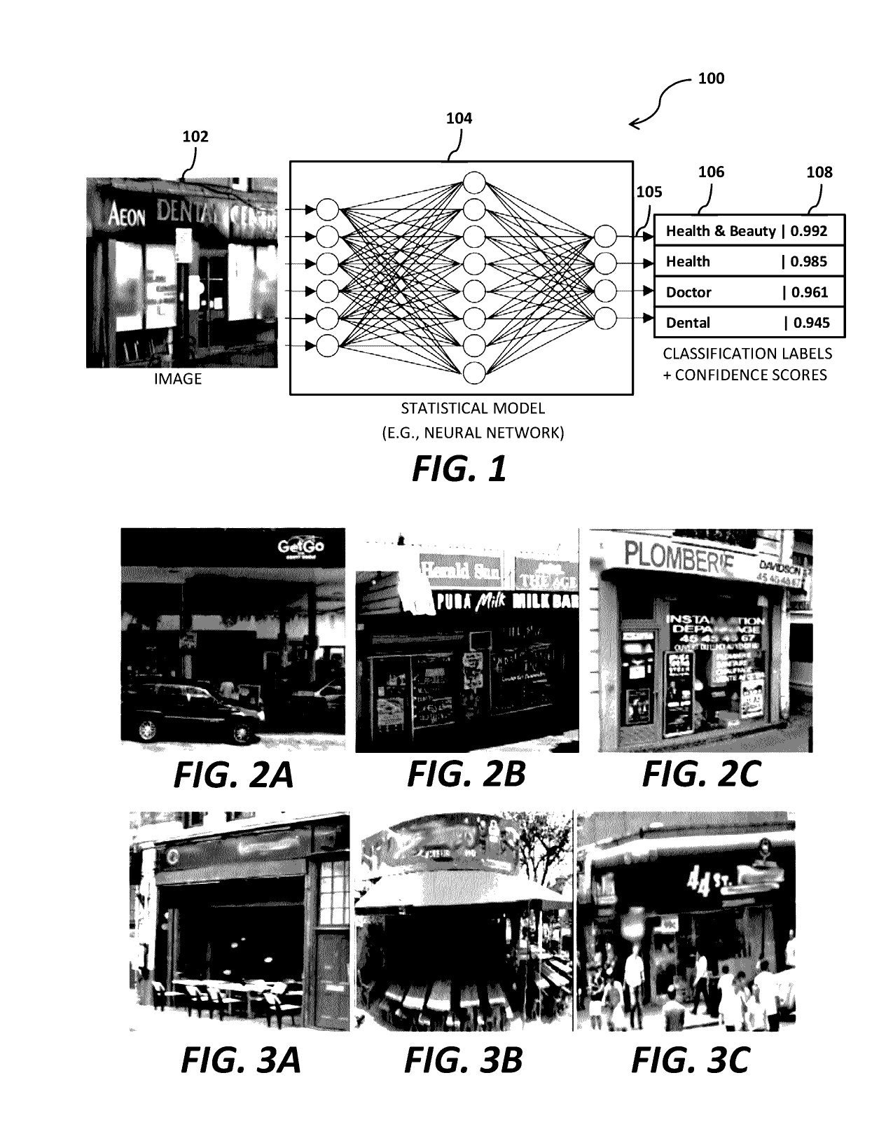

Referring now to the drawings, exemplary embodiments of the present disclosure will now be discussed in detail. FIG. 1 depicts an exemplary schematic 100 depicting various aspects of providing classification labels for a location entity. Schematic 100 generally includes an image 102 provided as input to a statistical model 104, such as but not limited to a neural network, which generates one or more outputs. Because the images analyzed in accordance with the disclosed techniques are intended to help classify a location entity within the image, image 102 generally corresponds to a street-level storefront view of a location entity. The particular image 102 shown in FIG. 1 provides a storefront view of a dental business, although it should be appreciated that the present disclosure can be equally applicable to other specific businesses as well as other types of location entities including but not limited to any feature, landmark, point of interest (POI), or other object or event associated with a geographic location. For instance, a location entity can include a business, restaurant, place of worship, residence, school, retail outlet, coffee shop, bar, music venue, attraction, museum, theme park, arena, stadium, festival, organization, region, neighborhood, or other suitable points of interest; or subsets of another location entity; or a combination of multiple location entities. In some examples, image 102 can correspond to a panoramic street-level image, such as those offered by Google Maps as “Street View” images. In some examples, image 102 contains only a bounded portion of such an image that can be identified as containing relevant information related to the business or other entity captured in image 102.

The statistical model 104 can be implemented in a variety of manners. In some embodiments, machine learning can be used to evaluate training images and develop classifiers that correlate predetermined image features to specific categories. For example, image features can be identified as training classifiers using a learning algorithm such as Neural Network, Support Vector Machine (SVM) or other machine learning process. Once classifiers within the statistical model are adequately trained with a series of training images, the statistical model can be employed in real time to analyze subsequent images provided as input to the statistical model.

In examples when statistical model 104 is implemented using a neural network, the neural network can be configured in a variety of particular ways. In some examples, the neural network can be a deep neural network and/or a convolutional neural network. In some examples, the neural network can be a distributed and scalable neural network. The neural network can be customized in a variety of manners, including providing a specific top layer such as but not limited to a logistics regression top layer. A convolutional neural network can be considered as a neural network that contains sets of nodes with tied parameters. A deep convolutional neural network can be considered as having a stacked structure with a plurality of layers.

Although statistical model 104 of FIG. 1 is illustrated as a neural network having three layers of fully-connected nodes, it should be appreciated that a neural network or other machine learning processes in accordance with the disclosed techniques can include many different sizes, numbers of layers and levels of connectedness. Some layers can correspond to stacked convolutional layers (optionally followed by contrast normalization and max-pooling) followed by one or more fully-connected layers. For neural networks trained by large datasets, the number of layers and layer size can be increased by using dropout to address the potential problem of overfitting. In some instances, a neural network can be designed to forego the use of fully connected upper layers at the top of the network. By forcing the network to go through dimensionality reduction in middle layers, a neural network model can be designed that is quite deep, while dramatically reducing the number of learned parameters. Additional specific features of an example neural network that can be used in accordance with the disclosed technology can be found in “Going Deeper with Convolutions,” Szegedy et al., arXiv: 1409.4842[cs], September 2014, which is incorporated by reference herein for all purposes.

Referring still to FIG. 1, after the statistical model 104 is applied to image 102, one or more outputs 105 can be generated. In some examples, outputs 105 of the statistical model include a plurality of classification labels 106 for the location entity in the image 102. In some examples, outputs 105 additionally include confidence scores 108 for each of the plurality of classification labels 106 to indicate a likelihood level that each generated classification label 106 is accurate for its corresponding location entity. In the particular example of FIG. 1, identified classification labels 106 categorize the location entity within image 102 as “Health & Beauty,” “Health,” “Doctor,” and “Dental.” Confidence scores 108 associated with these classification labels 106 indicate an estimated accuracy level of 0.992, 0.985, 0.961 and 0.945, respectively.

Types and amounts of classification labels 106 can vary in different embodiments of the disclosed technology. In some examples, the location entities correspond to businesses such that classification labels 106 provide multi-label fine grained classification of business storefronts. In some examples, the plurality of classification labels 106 for the location entity identified in image 102 includes at least one classification label 106 from a first hierarchical level of categorization (e.g., “Health & Beauty”) and at least one classification label from a second hierarchical level of categorization (e.g., “Dental.”) In some examples, the plurality of classification labels 106 are generated by selecting from an ontology that identifies different predetermined relationships between location entities and different categories associated with corresponding classification labels at multiple levels of granularity. In some examples, the plurality of classification labels 106 for the location entity can include at least one classification label from a general level of categorization that includes such options as an entertainment and recreation label, a health and beauty label, a lodging label, a nightlife label, a professional services label, a food and drink label and a shopping label. Although four different classification labels 106 and corresponding confidence scores are shown in the example of FIG. 1, other specific numbers and categorization parameters can be established in accordance with the disclosed technology.

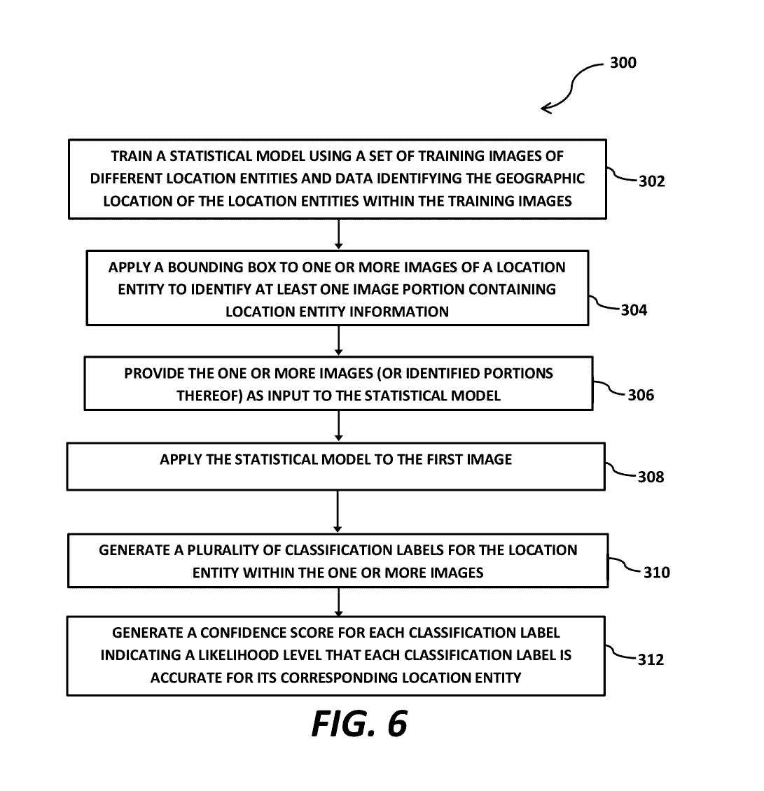

Referring now to FIGS. 2A-4C, respectively, the various images depicted in such figures help to provide context for the importance of providing accurate and automated systems and methods for classifying businesses from images. To understand the importance of associating a business or other location entity with multiple classification labels, consider the gas station shown in FIG. 2A. While its main purpose is fueling vehicles, it also serves as a convenience or grocery store. Any listing that does not capture this subtlety can be of limited value to its users. Similarly, large multi-purpose retail stores such as big-box stores or supercenters can sell a wide variety of products from fruit to home furniture, all of which should be reflected in their listings. The goal of accurate classification for these types of entities and others can involve a fine-grained classification approach since businesses of different types can differ only slightly in their visual appearance. An example of such a subtle difference can be captured by comparing FIGS. 2B and 2C. FIG. 2B shows the front of a grocery store, while FIG. 2C shows the front of a plumbing supply store. Visually, the storefronts depicted in FIGS. 2B and 2C are similar. The discriminative information within the images of FIGS. 2B and 2C can be very subtle, and appear in varying locations and scales in the images. These observations, combined with the large number of categories needed to cover the space of businesses, can require large amounts of training data for training a statistical model, such as neural network 104 of FIG. 1. Additional details of machine learning processes and statistical model training are discussed with reference to FIG. 6.

The disclosed classification techniques effectively address potentially large within-class variance when accurately predicting the function or classification of businesses of other location entities. The number of possible categories can be large, and the similarity between different classes can be smaller than within class variability. For example, FIGS. 3A-3C show three business storefronts whose names have been blurred. The businesses in FIGS. 3A and 3C are restaurants of some type, and the business in FIG. 3B sells furniture, in particular store benches. Without available text from the images in FIGS. 3A-3C, it is clear that techniques for accurately classifying intra-class variations (e.g., types of restaurants) can be equally important as determining differences between classes (e.g., restaurants versus retail stores). The disclosed technology advantageously provides techniques for addressing all such variations.

The disclosed classification techniques provide solutions for accurate business classification that do not rely purely on textual information within images. Although textual information in an image can assist the classification task, and can be used in combination with the disclosed techniques, OCR analysis of text strings available from an image is not required. This provides an advantage because of the various drawbacks that can potentially exist in some text-based models. The accuracy of text detection and transcription in real world images has increased significantly in recent years. However, relying solely on an ability to transcribe text can have drawbacks. For example, text can be in a language for which there is no trained model, or the language used can be different than what is expected based on the image location. In addition, determining which text in an image belongs to the business being classified can be a hard task and extracted text can sometimes be misleading.

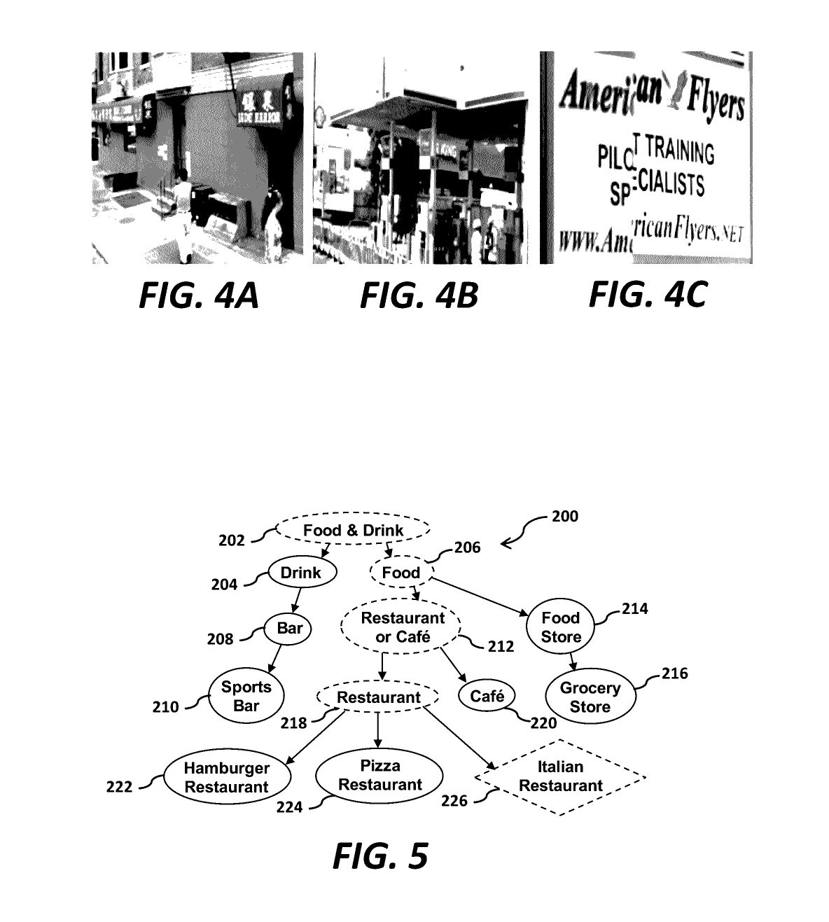

Referring more particularly to FIGS. 4A-4C, FIG. 4A depicts an example of encountering an image that contains text in a language (e.g., Chinese) different than expected based on location of the entity within the image (e.g., a geographic location within the United States of America). A system relying purely on textual analysis would fail in accurately classifying the image from FIG. 4A if it was missing a model that includes analysis of text from the Chinese language. When using only extracted text, dedicated models per language can require substantial effort in curating training data. Separate models can be required for different languages, requiring matching and maintaining of different models for each desired language and region. Even when a language model is perfect, relying on text can still be misleading. For example, identified text can come from a neighboring business, a billboard, or a passing bus. FIG. 4B depicts an example where the business being classified is a gas station, but available text includes the word “King,” which is part of a neighboring restaurant behind the gas station. Still further, panorama stitching errors such as depicted in FIG. 4C can potentially distort the text in an image and confuse the transcription process.

In light of potential issues that can arise as shown in FIGS. 4A-4C, the disclosed techniques advantageously can scale up to be used on images captured across many countries and languages. The present disclosure has all the advantages of using available textual information without the drawbacks mentioned above by implicitly learning to use textual cues within images, but being more robust to errors from systems that rely on textual analysis only.

An ontology for classification labels as used herein helps to create large scale labeled training data for fine grained storefront classification. In general, information from an ontology of entities with geographical attributes can be fused to propagate category information such that each image can be paired with multiple classification labels having different levels of granularity.

FIG. 5 provides a portion 200 of an example ontology describing relationships between geographical location entities that can be assigned classification labels associated with categories at multiple granularities in accordance with the disclosed technology. The ontology portion 200 of FIG. 5 depicts a first general level of categorization and corresponding classification label 202 of “Food & Drink.” The “Food & Drink” classification can be broken down into a second level of categorization corresponding to a “Drink” classification label 204 and a “Food” classification label 206. In some instances, the “Drink” classification label 204 can be more particularly categorized by a “Bar” classification label 208 and even more particularly by a “Sports Bar” classification label 210. The “Food” classification label 206 can be broken down into a third level of categorization corresponding to a “Restaurant or Café” classification label 212 and a “Food Store” classification label 214, the latter of which in some instances can be further categorized using a “grocery store” classification label 216. “Restaurant or Café” classification label 212 can be broken down into a fourth level of categorization corresponding to a “Restaurant” classification label 218 and a “Café” classification label 220. “Restaurant” classification label 218 can be still further designated by a fifth level of categorization including a “Hamburger Restaurant” classification label 222, a “Pizza Restaurant” classification label 224, and an “Italian Restaurant” classification label 226.

It should be appreciated that the relatively small snippet of ontology depicted in FIG. 5 can in actuality include many more levels of categorization and a much larger number of classification labels per categorization level when appropriate. For example, the most general level of categorization for businesses can include other classification labels than just “Food & Drink,” such as but not limited to “Entertainment & Recreation,” “Health & Beauty,” “Lodging,” “Nightlife,” “Professional Services,” and “Shopping.” In addition, there can be many other particular types of restaurants than merely Hamburger, Pizza and Italian Restaurants as depicted in FIG. 5 (e.g., Sushi Restaurants, Indian Restaurants, Fast Food Restaurants, etc.). In some examples, an ontology can be used that describes containment relationships between entities with a geographical presence, and can contain a large number of categories, on the order of about 2,000 or more categories in some examples.

Ontologies can be designed in order to yield a multiple label classification approach that includes many plausible categories for a business and thus many different classification labels. Different classification labels used to describe a given business or other location entity represent different levels of specificity. For example, a hamburger restaurant is also generally considered to be a restaurant. There is a containment relationship between these categories. Ontologies can be a useful way to hold hierarchical representations of these containment relationships. If a specific classification label c is known for a particular image portion p, c can be located in the ontology. The containment relations described by the ontology can be followed in order to add higher-level categories to the label set of p.

Referring again to the example of FIG. 5, the use of a predetermined ontology to propagate category information can be appreciated. If a given image is identified via a machine learning process to be an “ITALIAN RESTAURANT,” then the image initially could be assigned a classification label 226 corresponding to “ITALIAN RESTAURANT.” Once this initial classification label 226 is determined, the given image can also be assigned classification labels for all the predecessors' categories as well. Starting from the more specific classification label 226, containment relations can be followed up predecessors in the ontology portion 200 as represented by the classification labels having dashed lines until the most general or first level of categorization is reached. In the example of FIG. 5, this propagation starts at the “Italian Restaurant” classification label 226, and includes the “Restaurant” classification label 218, the “Restaurant & Café” classification label 212, the “Food” classification label 206 and finally the most general “Food & Drink” classification label 202. By applying this propagation technique, an “Italian Restaurant” can be identified using five different classification labels, corresponding to five different levels of granularity including first, second, third, fourth and fifth different hierarchical levels of categorization. It should be appreciated that in other examples, different containment relationships and corresponding classification labels can be possible, including having more than one classification label in each of one or more levels of categorization.

Referring now to FIG. 6, an example method (300) for classifying businesses from images includes training (302) a statistical model using a set of training images of different location entities and data identifying the geographic location of the location entities within the training images. The statistical model described in method (300) can correspond in some examples to statistical model 104 of FIG. 1. A statistical model can be trained at (302) in a variety of particular ways. Training the statistical model can include using a relatively large set of training images coupled with ontology-based classification labels. The training images can be of different location entities and data identifying the geographic location of the location entities within the training images, such that the statistical model outputs a plurality of classification labels for each training image.

In some examples, building a set of training data for training statistical model 104 can include matching extracted image portions p and sets of relevant classification labels. Each image portion can be matched with a particular business instance from a database of previously known businesses β that were manually verified by operators. Textual information and geographical location of the image can be used to match the image portion to a business. Text areas can be detected in the image, then transcribed using an Optical Character Recognition (OCR) software. Although this process requires a step of extracting text, it can be useful for creating a set of candidate matches. This provides a set of S text strings. The image portion can be geo-located and the location information can be combined with the textual data for that image. For each known business b ε β, the same description can be created by combining its location and the set T of all textual information that is available for that business (e.g., name, phone number, operating hours, etc.) Image portion p can be identified as a subset of β if the geographical distance between them is less than approximately one city block, and enough extracted text from S matches T. Using this technique, many pairs of data (p;b) can be created, for example, on the order of three million pairs of more.

Referring still to a task of training the statistical model at (302), a train/test data split can be created such that a subset of images (e.g., 1.2 million images) are used for training the network and the remaining images (e.g., 100,000) are used for testing. Since a business can be imaged multiple times from different angles, the train/test data splitting can be location aware. The fact that Street View panoramas are geotagged can be used to further help the split between training and test data. In one example, a globe of the Earth can be covered with two types of tiles: big tiles with an area of 18 kilometers and smaller tiles with an area of 2 kilometers. The tiling can alternate between the two types of tiles, with a boundary area of 100 meters between adjacent tiles. Panoramas that fall inside a big tile can be assigned to the training set, and those that are located in the smaller tiles can be assigned to the test set. This can ensure that businesses in the test set are never observed in the training set while making sure that training and test sets are sampled from the same regions. This splitting procedure can be fast and stable over time. When new data is available and a new split is made, train/test contamination can be avoided as the geographical locations are fixed. This can allow for incremental improvements of the system over time.

In some examples, training a statistical model at (302) can include pre-training using a predetermined subset of images and ground truth labels with a Soft Max top layer. Once the model has converged, the top layer in the statistical model can be replaced before the training process continues with a training set of images as described above. Such a pre-training procedure has been shown to be a powerful initialization for image classification tasks. Each image can be resized to a predetermined size, for example 256×256 pixels. During training, random crops of slightly different sizes (e.g., 220×220 pixels) can be given to the model as training images. The intensity of the images can be normalized, random photometric changes can be added and mirrored versions of the images can be created to increase the amount of training data and guide the model to generalize. In one testing example, a central box of size 220×220 pixels was used as input 102 to the statistical model 104, implemented as a neural network. The network was set to have a dropout rate of 70% (each neuron has a 70% chance of not being used) during training, and a Logistic Regression top layer was used. Each image was associated with a plurality of classification labels as described herein. This setup can be designed to push the network to share features between classes that are on the same path up the ontology.

Referring still to FIG. 6, one or more images can be introduced for processing using the statistical model trained at (302). In some examples, a bounding box can be applied to the one or more images at (304) in order to identify at least one portion of each image. In some examples, the bounding box can be applied at (304) in order to crop the one or more images to a desired pixel size. In some examples, the bounding box can be applied at (304) to identify a portion of each image that contains location entity information. For instance, the image portion created upon application of the bounding box at (304) could result in a cropped portion of each image that focuses on the storefront of the business or other location entity within the image, including optional relevant textual description provided at the storefront.

It should be appreciated that the application of a bounding box at (304) to one or more images can be an optional step. In some embodiments, application of a bounding box or other cropping technique may not be required at all. This can often be the case with indoor images or images that are already focused on a particular location entity or that are already cropped when obtained or otherwise provided for analyses using the disclosed systems and methods.

The one or more images or identified portions thereof created upon application of a bounding box at (304) then can be provided as input to the statistical model at (306). The statistical model then can be applied to the one or more images at (308). Application of the statistical model at (308) can involve evaluating the image relative to trained classifiers within the model such that a plurality of classification labels are generated at (310) to categorize the location entity within each image at multiple levels of granularity. The plurality of classification labels generated at (310) can be selected from the predetermined ontology of labels used to train the statistical model at (302) by evaluating the one or more input images at multiple processing layers. In some examples, a confidence score also can be generated at (312) for each classification label generated at (310).

In example implementations of method (300) using actual statistical model training, image inputs, and corresponding classification label outputs, results can be achieved that have human level accuracy. Method (300) can learn to extract and associate text patterns in multiple languages to specific business categories without access to explicit text transcriptions. Method (300) can also be robust to the absence of text. In addition, when distinctive visual information is available, method (300) can make accurate generation of classification labels having relatively high confidence scores. Additional performance data and system description for actual example implementations of the disclosed techniques can be found in “Ontological Supervision for Fine Grained Classification of Street View Storefronts,” Movshovitz-Attias et al., Proceedings of the IEEE Conference on Computer Vision and Pattern Recognition, June 2015, pp. 1693-1702, which is incorporated by reference herein in its entirety for all purposes.

The steps in FIG. 6 are discussed relative to one or more images. It should be appreciated that the disclosed features in method (300), including (304)-(312), respectively, can be applied to multiple images. In many cases, method (300) can be conducted for a plurality of images contained in a database. For example, method (300) can be conducted for each image in a collection of panoramic street level images that are stored for a plurality of identified businesses in order to enhance the data available to classify and categorize the business listings in the database.

In some examples of the disclosed technology, the generation (310) of a plurality of classification labels can be postponed unless and until a certain threshold amount of information is available for identifying at least one category or classification label. This option can be helpful to ensure that the classification of business listings generally remains at a very high level of accuracy. This can be useful by preventing unnecessary generation of inaccurate classification labels for a listing, which can potentially frustrate end users who are searching for business listings that use the classification labels generated by method (300). In such instances, a decision to complete generation (310) and later aspects of method (300) can be postponed until a later date if the category for some business images cannot be identified. Since a given business often can be imaged many times (from different angles and/or at different dates/times), it is possible that a category can be determined from a different image of the business. This affords the opportunity to build a classification label set for multiple imaged businesses incrementally as more image data becomes available, while keeping the overall accuracy of the listings high.

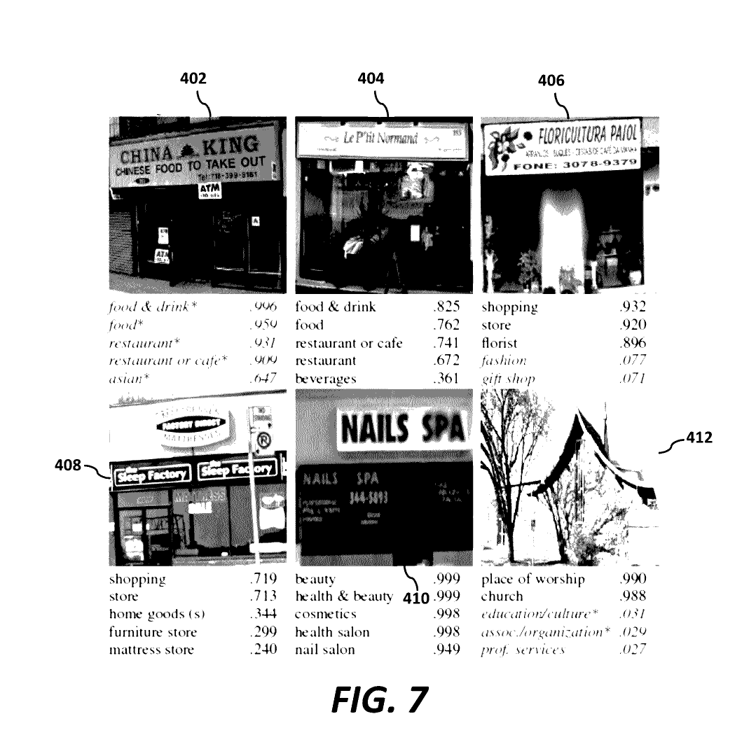

FIG. 7 depicts an example set of input images and statistical model outputs, including both classification labels and corresponding confidence scores. Example input image 402 can result in output classification labels and corresponding confidence scores including: (“food & drink”: 0.996), (“food”; 0.959), (“restaurant”; 0.931), (“restaurant or café”; 0.909), and (“Asian”; 0.647). Example input image 404 can result in output classification labels and corresponding confidence scores including: (“food & drink”: 0.825), (“food”; 0.762), (“restaurant or café”; 0.741), (“restaurant”; 0.672), and (“beverages”; 0.361). Example input image 406 can result in output classification labels and corresponding confidence scores including: (“shopping”: 0.932), (“store”; 0.920), (“florist”; 0.896), (“fashion”; 0.077), and (“gift shop”; 0.071). Example input image 408 can result in output classification labels and corresponding confidence scores including: (“shopping”: 0.719), (“store”; 0.713), (“home good(s)”; 0.344), (“furniture store”; 0.299), and (“mattress store”; 0.240). Example input image 410 can result in output classification labels and corresponding confidence scores including: (“beauty”: 0.999), (“health & beauty”; 0.999), (“cosmetics”; 0.998), (“health salon”; 0.998), and (“nail salon”; 0.949). Example input image 412 can result in output classification labels and corresponding confidence scores including: (“place of worship”: 0.990), (“church”; 0.988), (“education/culture”; 0.031), (“association/organization”; 0.029), and (“professional services”; 0.027).

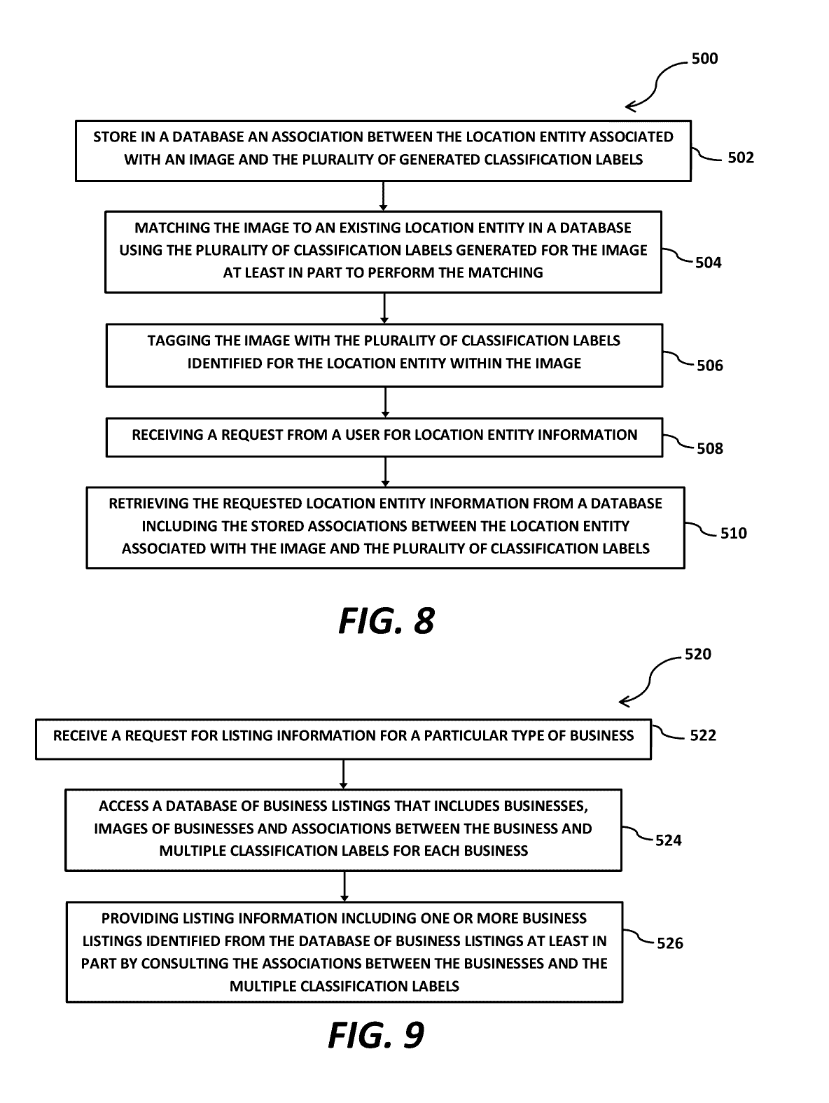

Referring now to FIG. 8, method (500) depicts additional features for utilizing the generated plurality of classification labels provided as output from the statistical model in a variety of specific applications. In some examples, an association between the location entity associated with one or more images and the plurality of generated classification labels can be stored in a database at (502). In some examples, the location entities from the images correspond to businesses and the database of stored associations includes business information for the businesses as well as the associations between the business associated with each image and the plurality of generated classification labels. In some examples, one or more images can be matched at (504) to an existing location entity in a database using the plurality of classification labels generated at (310) at least in part to perform the matching at (504). In some examples, the images provided as input to the statistical model are subsequently tagged at (506) with one or more of the plurality of classification labels generated at (310) as output. In other examples, a request from a user for information pertaining to a business or other location entity can be received at (508). The requested business or location entity information then can be retrieved at (510) from the database that includes the stored associations between the business or location entity associated with an image and the plurality of generated classification labels.

Referring now to FIG. 9, method (520) of processing a business-related search query includes receiving a request at (522) for listing information for a particular type of business or other location entity. The request (522) can optionally include additional time or location parameters. A database of business listings that comprises businesses, images of the businesses, and associations between the businesses and multiple classification labels can be accessed at (524). In some examples, the associations between the businesses and multiple classification labels can be identified by providing each image of a business as input to a statistical model, applying the statistical model to each image of the business, generating the multiple classification labels for the business, and providing the multiple classification labels for the business as output of the statistical model. Listing information then can be provided as output at (526), including one or more business listings identified from the database of business listings at least in part by consulting the associations between the businesses and multiple classification labels.

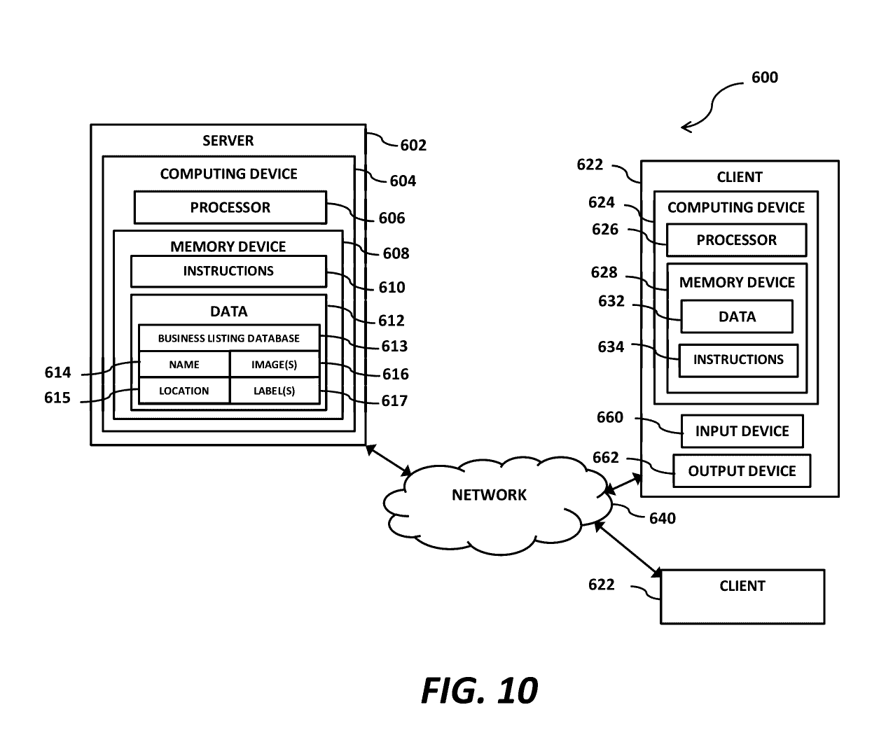

FIG. 10 depicts a computing system 600 that can be used to implement the methods and systems for classifying businesses or other location entities from images according to example embodiments of the present disclosure. The system 600 can be implemented using a client-server architecture that includes a server 602 and one or more clients 622. Server 602 may correspond, for example, to a web server hosting a search engine application as well as optional image processing related machine learning tools. Client 622 may correspond, for example, to a personal communication device such as but not limited to a smartphone, navigation system, laptop, mobile device, tablet, wearable computing device or the like configured for requesting business-related search query information.

Each server 602 and client 622 can include at least one computing device, such as depicted by server computing device 604 and client computing device 624. Although only one server computing device 604 and one client computing device 624 is illustrated in FIG. 10, multiple computing devices optionally may be provided at one or more locations for operation in sequence or parallel configurations to implement the disclosed methods and systems of classifying businesses from images. In other examples, the system 600 can be implemented using other suitable architectures, such as a single computing device. Each of the computing devices 604, 624 in system 600 can be any suitable type of computing device, such as a general purpose computer, special purpose computer, navigation system (e.g. an automobile navigation system), laptop, desktop, mobile device, smartphone, tablet, wearable computing device, a display with one or more processors, or other suitable computing device.

The computing devices 604 and/or 624 can respectively include one or more processor(s) 606, 626 and one or more memory devices 608, 628. The one or more processor(s) 606, 626 can include any suitable processing device, such as a microprocessor, microcontroller, integrated circuit, logic device, one or more central processing units (CPUs), graphics processing units (GPUs) dedicated to efficiently rendering images or performing other specialized calculations, and/or other processing devices. The one or more memory devices 608, 628 can include one or more computer-readable media, including, but not limited to, non-transitory computer-readable media, RAM, ROM, hard drives, flash drives, or other memory devices. In some examples, memory devices 608, 628 can correspond to coordinated databases that are split over multiple locations.

The one or more memory devices 608, 628 store information accessible by the one or more processors 606, 626, including instructions that can be executed by the one or more processors 606, 626. For instance, server memory device 608 can store instructions for implementing an image classification algorithm configured to perform various functions disclosed herein. The client memory device 628 can store instructions for implementing a browser or application that allows a user to request information from server 602, including search query results, image classification information and the like.

The one or more memory devices 608, 628 can also include data 612, 632 that can be retrieved, manipulated, created, or stored by the one or more processors 606, 626. The data 612 stored at server 602 can include, for instance, a database 613 of listing information for businesses or other location entities. In some examples, business listing database 613 can include more particular subsets of data, including but not limited to name data 614 identifying the names of various businesses, location data 615 identifying the geographic location of the businesses, one or more images 616 of the businesses, and classification labels 617 generated from the image(s) 616 using aspects of the disclosed techniques.

Computing devices 604 and 624 can communicate with one another over a network 640. In such instances, the server 602 and one or more clients 622 can also respectively include a network interface used to communicate with one another over network 640. The network interface(s) can include any suitable components for interfacing with one more networks, including for example, transmitters, receivers, ports, controllers, antennas, or other suitable components. The network 640 can be any type of communications network, such as a local area network (e.g. intranet), wide area network (e.g. Internet), cellular network, or some combination thereof. The network 640 can also include a direct connection between server computing device 604 and client computing device 624. In general, communication between the server computing device 604 and client computing device 624 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The client 622 can include various input/output devices for providing and receiving information to/from a user. For instance, an input device 660 can include devices such as a touch screen, touch pad, data entry keys, and/or a microphone suitable for voice recognition. Input device 660 can be employed by a user to request business search queries in accordance with the disclosed embodiments, or to request the display of image inputs and corresponding classification label and/or confidence score outputs generated in accordance with the disclosed embodiments. An output device 662 can include audio or visual outputs such as speakers or displays for indicating outputted search query results, business listing information, and/or image analysis outputs and the like.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

It will be appreciated that the computer-executable algorithms described herein can be implemented in hardware, application specific circuits, firmware and/or software controlling a general purpose processor. In one embodiment, the algorithms are program code files stored on the storage device, loaded into one or more memory devices and executed by one or more processors or can be provided from computer program products, for example computer executable instructions, that are stored in a tangible computer-readable storage medium such as RAM, flash drive, hard disk, or optical or magnetic media. When software is used, any suitable programming language or platform can be used to implement the algorithm.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of providing classification labels for location entities from imagery, comprising:
providing, using one or more computing devices, one or more images of a location entity as input to a statistical model;
applying, using the one or more computing devices, the statistical model to the one or more images;
generating, using the one or more computing devices, a plurality of classification labels for the location entity in the one or more images, wherein the plurality of classification labels are generated by selecting from an ontology that identifies predetermined relationships between location entities and categories associated with corresponding classification labels at multiple levels of granularity; and
providing, using the one or more computing devices, the plurality of classification labels as an output of the statistical model.

2. The computer-implemented method of claim 1, further comprising storing in a database, using the one or more computing devices, an association between the location entity associated with the one or more images and the plurality of generated classification labels.

3. The computer-implemented method of claim 2, wherein the location entity comprises a business and wherein the database comprises business information for the location entity as well as the association between the business associated with the one or more images and the plurality of generated classification labels.

4. The computer-implemented method of claim 3, further comprising:
receiving, using the one or more computing devices, a request from a user for business information; and
retrieving, using the one or more computing devices, the requested business information from the database including the stored associations between the business associated with the one or more images and the plurality of generated classification labels.

5. The computer-implemented method of claim 3, further comprising matching, using the one or more computing devices, the one or more images to an existing business in the database using the plurality of classification labels generated for the one or more images at least in part to perform the matching.

6. The computer-implemented method of claim 1, further comprising applying, using the one or more computing devices, a bounding box to the one or more images, wherein the bounding box identifies at least one portion of the one or more images containing entity information related to the location entity, and wherein the identified at least one portion of the one or more images is provided as the input to the statistical model.

7. The computer-implemented method of claim 1, further comprising training, using the one or more computing devices, the statistical model using a set of training images of different location entities and data identifying the geographic location of the location entities within the training images, the statistical model outputting a plurality of classification labels for each training image.

8. The computer-implemented method of claim 1, further comprising generating, using the one or more computing devices, a confidence score for each of the plurality of classification labels for the location entity identified in the one or more images, wherein each confidence score indicates a likelihood level that each generated classification label is accurate for its corresponding location entity.

9. The computer-implemented method of claim 1, wherein the plurality of classification labels include at least one classification label from a first hierarchical level of categorization and at least one classification label from a second hierarchical level of categorization.

10. The computer-implemented method of claim 1, wherein the plurality of classification labels for the location entity comprises at least one classification label from a general level of categorization, the general level of categorization including one or more of an entertainment and recreation label, a health and beauty label, a lodging label, a nightlife label, a professional services label, a food and drink label and a shopping label.

11. The computer-implemented method of claim 1, further comprising tagging, using the one or more computing devices, the one or more images with the plurality of classification labels identified for the location entity in the one or more images.

12. The computer-implemented method of claim 1, wherein the location entity comprises a business.

13. The computer-implemented method of claim 1, wherein the one or more images comprise panoramic street-level images of the location entity.

14. The computer-implemented method of claim 1, wherein the statistical model is a neural network.

15. The computer-implemented method of claim 1, wherein the statistical model is a deep convolutional neural network with a logistic regression top layer.

16. A computer-implemented method of processing a business-related search query, comprising:
receiving, using one or more computing devices, a request for listing information for a particular type of business;
accessing, using the one or more computing devices, a database of business listings that comprises businesses, images of the businesses, and associations between the businesses and multiple classification labels;
wherein the associations between the businesses and multiple classification labels are identified by providing each image of a business as input to a statistical model, applying the statistical model to each image of the business, generating the multiple classification labels for the business, and providing the multiple classification labels for the business as output of the statistical model; and
providing, using the one or more computing devices, listing information including one or more business listings identified from the database of business listings at least in part by consulting the associations between the businesses and multiple classification labels.

17. The computer-implemented method of claim 16, wherein the multiple classification labels include at least one classification label from a first hierarchical level of categorization and at least one classification label from a second hierarchical level of categorization.

18. A computing device, comprising:
one or more processors; and
one or more memory devices, the one or more memory devices storing computer-readable instructions that when executed by the one or more processors, cause the one or more processors to perform operations, the operations comprising:
providing one or more images of a location entity an input to a statistical model;
applying the statistical model to the one or more images;
generating a plurality of classification labels for the location entity in the one or more images, wherein the plurality of classification labels are generated by selecting from an ontology that identifies predetermined relationships between location entities and categories associated with corresponding classification labels at multiple levels of granularity; and
providing the plurality of classification labels as an output of the statistical model.

19. The computing device of claim 18, wherein the operations further comprise generating a confidence score for each of the plurality of classification labels for the location entity identified in the one or more images, wherein each confidence score indicates a likelihood level that each generated classification label is accurate for its corresponding location entity.

20. The computing device of claim 18, wherein the location entity comprises a business and wherein the operations further comprise:
storing in a database an association between the business associated with the one or more images and the plurality of generated classification labels;
receiving a request from a user for business information; and
retrieving the requested business information from the database including the stored associations between the business associated with the one or more images and the plurality of generated classification labels.
